(19) United States
(12) Patent Application Publication
(10) Pub. No.: US 2019/0248688 A1
(43) Pub. Date: Aug. 15, 2019

(54) METHOD OF TREATING WASTEWATER AND SYSTEMS THEREOF

(71) Applicant: Iowa State University Research Foundation, Inc., Ames, IA (US)

(72) Inventors: ZHIYOU WEN, Ames, IA (US); MARTIN ANTHONY GROSS, Ames, IA (US)

(21) Appl. No.: 16/257,691

(22) Filed: Jan. 25, 2019

Related U.S. Application Data
(60) Provisional application No. 62/628,548, filed on Feb. 9, 2018.

(51) Int. Cl. C02F 3/32; C02F 3/00; C02F 3/02; C02F 3/30; C02F 3/12

(52) U.S. Cl. CPC C02F 3/325; C02F 3/006; C02F 3/121; C02F 3/305; C02F 3/308; C02F 3/025

(57) ABSTRACT

The present invention relates to a method for treating wastewater. The method includes treating an influent flow of raw wastewater from one or more sources in a harvestable algae biofilm treatment system. The treated wastewater is then delivered to one or more wastewater treatment lagoons or a mechanized biological treatment system for additional treatment. Also disclosed is a system for treating wastewater.

This application claims the benefit of U.S. Provisional Patent Application Ser. No. 62/628,548 filed Feb. 9, 2018, which is hereby incorporated by reference in its entirety.

### FIELD OF THE INVENTION

The present invention relates to a method of treating wastewater and systems thereof. More specifically, the present invention relates to a method for treating domestic wastewater using a harvestable algae biofilm treatment system located prior to one or more wastewater treatment lagoons.

### BACKGROUND OF THE INVENTION

Environmental agencies are reducing the level of nutrients, such as nitrogen and phosphorous, that can be released into surface waters. Many municipal wastewater treatment plants are not designed to meet these new, more stringent, nutrient discharge limits. As a result, municipalities are faced with completely redesigning or significantly retrofitting their existing wastewater treatment systems at significant costs in order to meet the new requirements.

The new requirements are particularly burdensome in rural communities that primarily rely on pond or lagoon systems to treat domestic wastewater. Such systems, which rely on algal cultivation in the open ponds, do not adequately remove certain nutrients, such as ammonia, from the domestic wastewater. As a result, the effluent discharged from these wastewater treatment systems has high levels of nutrients that pollute the surrounding ecosystem.

This problem is exacerbated during the winter season due to low temperatures. Specifically, with respect to ammonia, the pond wastewater treatment systems rely on nitrification bacteria to remove the ammonia. However, nitrification bacteria have low activity during low temperatures, which leads to poor ammonia removal during colder seasons.

The new ammonia permit requirements are therefore burdensome to small communities as their lagoon treatment systems are incapable of attaining the required levels of nitrification, particularly during colder seasons when nitrification slows down, resulting in ammonia levels increasing over the permit limits. Current methodologies for nutrient removal from lagoon wastewater are performed inside or after the lagoon. Such methodologies allow the heat of the raw wastewater to be dissipated to the lagoon prior to treatment resulting in suboptimal nutrient removal.

Other technologies are available to help communities meet the new nutrient removal standards, such as ammonia permits, including a submerged attached growth reactor system (SAGR), a Lemna cover, Nitrox, or mechanized plants. However, these technologies are often costly to implement and require a large retrofit or entire replacement of the existing wastewater treatment lagoon systems currently in place.

The present invention is directed to overcoming these and other deficiencies in the art.

### SUMMARY OF THE INVENTION

One aspect of the present invention relates to a method for treating wastewater. The method includes treating an influent flow of raw wastewater from one or more sources in a harvestable algae biofilm treatment system. The treated wastewater is then delivered to one or more wastewater treatment lagoons for additional treatment.

Another aspect of the present invention relates to the method of the present invention wherein the harvestable algae biofilm treatment system includes a flexible sheet material mounted on a frame that supports the growth and attachment of algae. The flexible sheet material has a substantially vertical orientation when mounted on the frame such that a height of the flexible sheet material is greater than a width of the flexible sheet material. A drive system is coupled with the frame to move the flexible sheet material. A roller is coupled with the frame to rotate the flexible sheet material, when the flexible sheet material is moved by the drive system, through a liquid zone and a gaseous zone. In the liquid zone the flexible sheet material is rotated through a contacting liquid retained within a fluid reservoir and in the gaseous zone the flexible sheet material is rotated through a sunlight capture area. A majority of the flexible sheet material is positioned within the gaseous zone and a minority of the flexible sheet material is positioned within the liquid zone. A harvesting mechanism is positioned entirely within the sunlight capture area associated with the gaseous zone.

A further aspect of the present invention relates to a water treatment system. The water treatment system includes a harvestable algae biofilm treatment system positioned to receive an influent flow of raw wastewater from one or more sources. A wastewater treatment lagoon is coupled to the algal treatment system through one or more conduits to receive the treated wastewater from the harvestable algae biofilm treatment system.

This technology advantageously provides a method and system for treating wastewater that provides for more efficient removal of nutrients by using a harvestable algae biofilm treatment system to treat an influent flow raw wastewater from one or more sources prior to delivery to one or more wastewater treatment lagoons for additional treatment prior. This allows for algal treatment of warm wastewater from the community sewage pipeline, which enhances the efficiency of nutrient removal from the wastewater in comparison to traditional algal treatment raceway ponds, particularly in areas that experience colder temperatures. Further, the positioning of the algal treatment system to receive the warm influent flow wastewater allows for providing an algal system that does not need to be separately heated.

The method and system of the present invention further allow wastewater treatment lagoon systems, particularly in rural communities, to be retrofitted with an algal treatment system to enhance nutrient removal efficiency. The enhanced nutrient removal in turn reduces pollution from those nutrients in the ecosystem surrounding the wastewater treatment lagoons.

### BRIEF DESCRIPTION OF THE DRAWINGS

FIG. 1 is an exemplary environment including a wastewater treatment system of the present invention.

FIG. 2 is an exemplary flow chart of one embodiment of the method of the present invention.

FIG. 3 is a partial cutaway perspective view of a revolving algal biofilm photobioreactor according to one embodiment of the present invention.

FIG. 4 is a schematic front view of the revolving algal biofilm photobioreactor illustrated in FIG. 3.

FIG. 5 is a top view of microalgae being grown on a variety of materials.

FIG. 6 is a bar chart of harvesting frequencies for an algal strain according to one embodiment.

FIG. 7 is a partial cutaway perspective view of the revolving algal biofilm bioreactor illustrated in FIG. 3, shown with grow lights and a gas input.

FIG. 8 is a partial exploded view of the revolving algal biofilm bioreactor shown in FIG. 3.

FIG. 9 is a perspective view of a revolving algal biofilm bioreactor of the present invention, having a plurality of associated algal growth systems and a raceway according to one embodiment.

FIG. 10 is a perspective view of the algal growth system illustrated in FIG. 9.

FIG. 11 is a perspective view of the raceway illustrated in FIG. 9.

FIG. 12 is a perspective view of a revolving algal biofilm bioreactor of the present invention, having a plurality of associated algal growth systems and a raceway according to an alternate embodiment.

FIG. 13 is a perspective view of the algal growth system illustrated in FIG. 12.

FIG. 14 is a perspective view of a revolving algal biofilm bioreactor of the present invention, having an associated algal growth system and a trough system according to one embodiment.

FIG. 15 is a perspective view of the algal growth system illustrated in FIG. 14.

FIG. 16 is a perspective view of the trough system illustrated in FIG. 14.

FIG. 17 is a perspective view of an algal growth system shown with a harvesting system according to one embodiment of the present invention.

FIG. 18 is a perspective view of an algal growth system according to one embodiment of the present invention.

FIG. 19 is a perspective view of a photobioreactor according to one embodiment of the present invention.

FIGS. 20A and 20B are graphs of temperature versus date for the daily influent (FIG. 20A) and effluent (FIG. 20B) for a pilot-scale revolving algal biofilm (RAB) system.

FIGS. 21A and 21B are graphs of air temperature versus date for the daily air temperature inside (FIG. 21A) and outside (FIG. 21B) the greenhouse structure for the pilot-scale RAB system.

FIG. 22 is a graph of ammonia concentration versus date for the influent (empty dots) and the effluent (filled dots) of the pilot-scale RAB system. The shaded portions represent periods where the system was intentionally shut down for testing how fast the treatment efficacy recovered.

FIG. 23 is a graph of the percentage of ammonia removed by the pilot-scale RAB system versus date. The shaded portions represent periods where the system was intentionally shut down for testing how fast the treatment efficacy recovered.

FIG. 24 is a graph of the mass of ammonia removed by the pilot-scale RAB system versus date.

FIG. 25 is a graph of COD concentration versus date in the influent (empty dots) and effluent (filled dots) of the pilot-scale RAB system. The shaded portions represent periods where the system was intentionally shut down for testing how fast the treatment efficacy recovered.

FIG. 26 is COD concentration in the influent and effluent of the pilot scale RAB system. The shaded portions represent periods where the system was intentionally shut down for testing how fast the treatment efficacy recovered.

FIG. 27 is a graph of the mass of COD removed by the pilot-scale RAB system versus date.

### DETAILED DESCRIPTION OF THE INVENTION

The present invention relates to a method and system for treating wastewater.

One aspect of the present invention relates to a method for treating wastewater. The method includes treating an influent flow of raw wastewater from one or more sources in a harvestable algae biofilm treatment system. The treated wastewater is then delivered to one or more wastewater treatment lagoons for additional treatment.

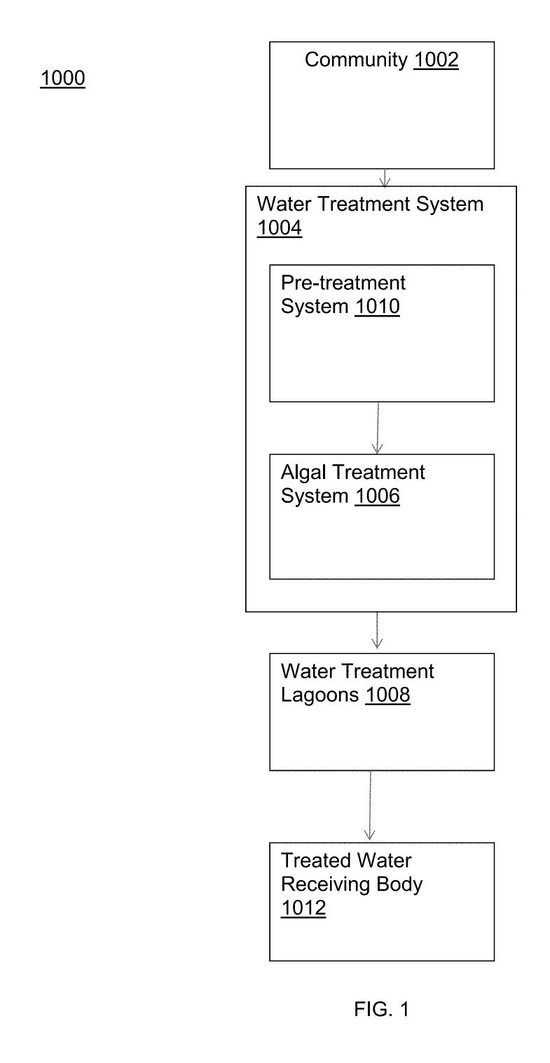

FIG. 1 is an exemplary environment 1000 including a community 1002 that provides an influent flow of raw wastewater to a wastewater treatment system 1004, including an algal treatment system 1006 and one or more wastewater treatment lagoons 1008, for performing the wastewater treatment methods of the present invention. In this example, environment 1000 also includes an additional pre-treatment system 1010, such as a solid separation pit or one or more filters, located to receive and treat the influent flow of raw wastewater from community 1002 prior to wastewater treatment system 1004, although environment 1000 may also include additional wastewater treatment systems located prior to, or after, wastewater treatment system 1004. Environment 1000 further includes a treated water receiving body 1012, such as a creek or river, for receiving treated wastewater from wastewater treatment system 1004.

Community 1002 produces and provides an influent flow of raw wastewater through a raw wastewater collection system into wastewater treatment system 1004. Community 1002 may be any community that relies on a wastewater treatment lagoon system, such as wastewater treatment lagoons 1008 in environment 1000, for treating raw domestic wastewater. The raw domestic wastewater includes solid waste and is generally ammonia and chemical oxygen demand rich. In one example, community 1002 is a rural community with minimal industry having a lagoon system with an average daily flow rate of raw wastewater of about 0.220 million gallons per day (MGD), with a peak of about 1.160 MGD and a minimum of about 0.048 MGD. In another example, community 1002 has a lagoon system with an average daily flow rate of raw wastewater of about 0.278 MGD, with a peak of about 1.293 MGD and a minimum of about 0.018 MGD. However, the methods of the present invention can be utilized in other communities that rely on wastewater treatment lagoons having different sizes and natures with higher or lower flow rates. Algal treatment system 1004 may be sized to accommodate different influent flow rates depending on the size and nature of community 1002 as discussed in further detail below.

Wastewater treatment system 1004 includes algal treatment system 1006 and wastewater treatment lagoons 1008. Algal treatment system 1006 may be any wastewater treatment system, such as a harvestable algae biofilm treatment system, that treats raw wastewater using a microalga based treatment for nutrient removal, such as hyper-concentrated cultures, immobilized cell systems, dialysis cultures, algal mats, or tubular photo-bioreactors. In another example, algal treatment system 1006 is a revolving algal biofilm (RAB) treatment system as described in U.S. Pat. No. 9,932,549, the disclosure of which is hereby incorporated by reference in its entirety.

Suitable algal cells (including cyanobacteria) as well as fungal strains, such as strains that can be used in aquaculture feed, animal feed, nutraceuticals, or biofuel production can be used in algal treatment system 1006. Such strains can include Nannochloropsis sp., Scenedesmus sp., Haematococcus sp., Botryococcus sp., Dunaliella sp., and/or a group of microalgae species including Arthrospira, Porphyridium, Phaeodactylum, Nitzschia, Crypthecodinium and Schizochytrium. It will be appreciated that the listed genus and species are described by way of example and additions and combinations are contemplated. The algal treatment system 1006 is utilized for nutrient removal including treatment for removing total nitrogen and/or total phosphorous, as well as reducing the chemical oxygen demand of the raw wastewater.

Algal treatment system 1006 is located to receive the influent flow of raw wastewater from community 1002. In one example, additional pre-treatment system 1010 is located prior to algal treatment system 1006. In one example, pre-treatment system 1010 is a solid separation pit configured to provide solid-free wastewater to algal treatment system 1006 through settling of solids from the influent flow of raw wastewater. Alternatively, pre-treatment system 1010 may include a filtering system including a 100 nm to 10 cm filter to provide a filtered influent flow of water to algal treatment system 1006.

Algal treatment system 1006 is further located upstream of wastewater treatment lagoons 1008 in order to deliver treated wastewater to wastewater treatment lagoons 1008. In another example, algal treatment system 1006 is located upstream of a mechanized biological treatment system, such as an aeration basin, activated sludge, trickling filter, or a rotating biological contactor. Algal treatment system 1006 provides a pretreatment that reduces nutrients, such as nitrogen and phosphorus, in the wastewater prior to entering wastewater treatment lagoons 1008. Algal treatment system 1006 may be spiked with a specified group of microorganisms in order to enhance nutrient removal (such as ammonia and total nitrogen), as known in the art of treating wastewater.

The location of algal treatment system 1006 advantageously utilizes the heat in the warm influent flow of wastewater to keep algal treatment system 1006 warm to maintain high levels of algal activity for nutrient absorption. In one example, algal treatment system 1006 is housed in a greenhouse structure to further maintain the heat of the warm influent wastewater. In one example, the influent wastewater has a temperature between 40-70 degrees Fahrenheit.

Algal treatment system 1006 may be located in close proximity to wastewater treatment lagoons 1008. Algal treatment system 1006 may be sized as described below to accommodate the incoming flow rate of raw wastewater. In one example, algal treatment system 1006 has a modular design with multiple treatment systems linked together to treat larger amounts of influent flow. The modular design makes operation of algal treatment system 1006 more robust and resilient. Independent modules allow algal treatment system 1006 to remain operational if one unit breaks down. The modular design also significantly reduces the cost of fabricating the redundant algal treatment systems 1006, which will reduce the cost for rural communities to implement this system. Algal treatment system 1006 may be applied with existing water treatment lagoons to retrofit the water treatment system to address increased nutrient removal standards. This avoids costly redesigns of the overall system. Algal treatment system 1006 may be sized based on the average daily flow rate of raw wastewater from community 1002.

One aspect of present invention relates to method of the present invention wherein the harvestable algae biofilm treatment system includes a flexible sheet material mounted on a frame that supports the growth and attachment of algae. The flexible sheet material has a substantially vertical orientation when mounted on the frame such that a height of the flexible sheet material is greater than a width of the flexible sheet material. A drive system is coupled with the frame to move the flexible sheet material. A roller is coupled with the frame to rotate the flexible sheet material, when the flexible sheet material is moved by the drive system, through a liquid zone and a gaseous zone. In the liquid zone the flexible sheet material is rotated through a contacting liquid retained within a fluid reservoir and in the gaseous zone the flexible sheet material is rotated through a sunlight capture area. A majority of the flexible sheet material is positioned within the gaseous zone and a minority of the flexible sheet material is positioned within the liquid zone. A harvesting mechanism is positioned entirely within the sunlight capture area associated with the gaseous zone.

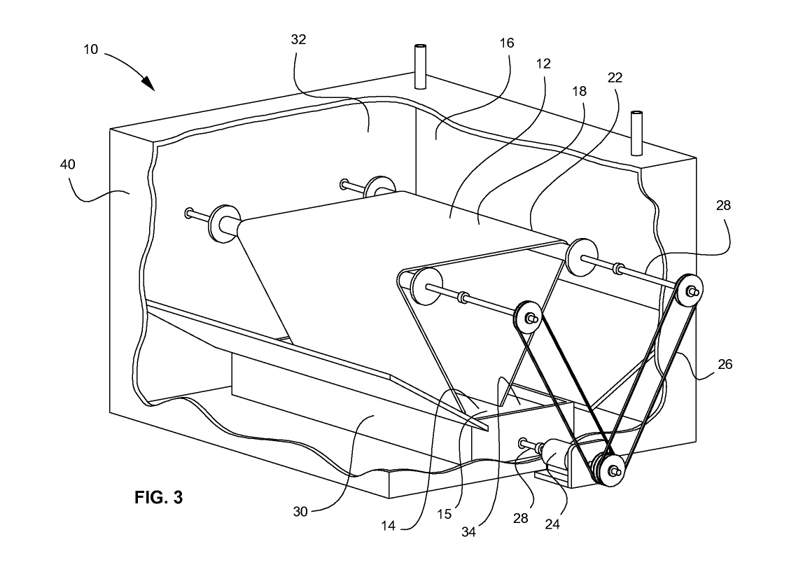

Referring now to FIGS. 3, 4, 7, and 8, an example embodiment of a revolving algal biofilm photobioreactor (RAB) 10 that may be utilized in algal treatment system 1006 is illustrated. Photobioreactor 10 provides a system that enhances cell growth and provide for improved removal of nutrients using harvesting of algal biomass. Algal cells can be attached to a material that can be rotated between a liquid phase and a gaseous zone such that alternative absorption of nutrients and carbon dioxide can occur to enhance nutrient removal to mitigate air and water pollution.

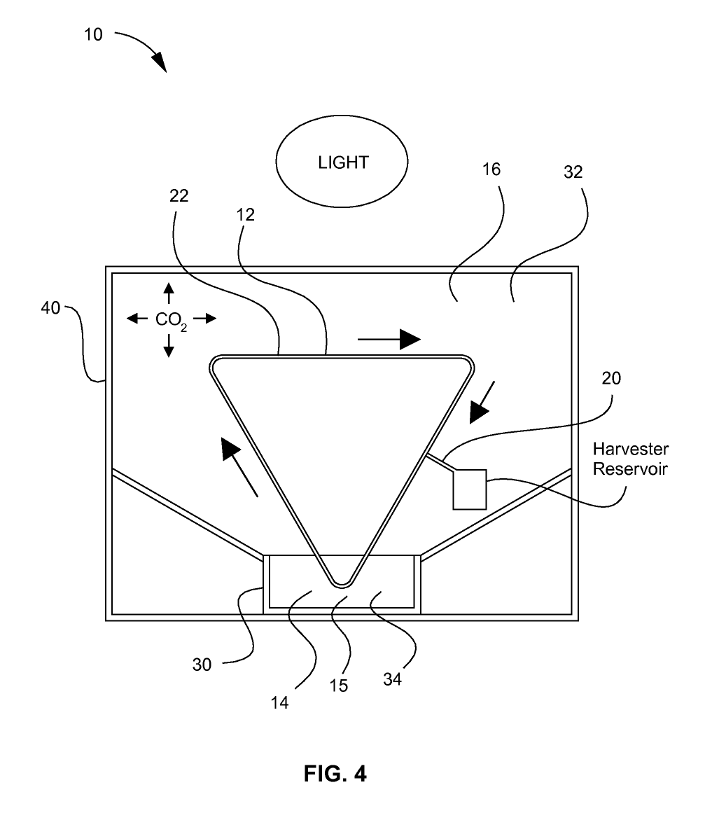

Photobioreactor 10 includes a solid surface of a supporting material 12 to which algal cells 18 can be attached. Photobioreactor 10 can keep the algal cells 18 fixed in one place and can bring nutrients to the cells. This avoids having to suspend the algae in a culture medium. As shown in FIGS. 3 and 4, algal cells can be attached to the supporting material 12 that is rotatable between a nutrient-rich liquid phase zone 15 and a CO2-rich gaseous phase zone 16 for alternative absorption of nutrients and carbon dioxide.

The algal biomass can be harvested by scrapping the biomass from the attached surface with a harvesting squeegee 20, as shown in FIG. 4, or other suitable device or system. In exemplary embodiments, the naturally concentrated biofilm can be in-situ harvested during the culture process, rather than using an additional sedimentation or flocculation step for harvesting, for example. The culture can enhance the mass transfer by directly contacting algal cells with CO2 molecules in gaseous phase, where traditional suspended culture systems may have to rely on the diffusion of CO2 molecules from gaseous phase to the liquid phase, which may be limited by low gas-liquid mass transfer rates. Exemplary embodiments may only need a small amount of water by submerging the bottom of the triangle-shaped algal growth system or mechanized harvesting system 22 in contacting liquid 14 while maximizing surface area for algae to attach. Exemplary embodiments can be scaled up to an industrial scale, because the system may have a simple structure and can be retrofit on existing raceway pond systems. Referring to FIG. 7, a gas input 43 and grow lights 42 having any suitable wavelength can be provided in the system.

Still referring to FIGS. 3, 4, 7, and 8, embodiments of the system can include a drive motor 24 and a gear system or pulley system 26 that can rotate one or more drive shafts 28, where the one or a plurality of drive shafts 28 can correspondingly rotate the supporting material 12, such as a flexible sheet material. The supporting material 12 can be rotated into contact with the contacting liquid 14, which can allow the algal cells 18 to attach to the supporting material 12. Drive motor 24 can include gear system or pulley system 26 that can rotate drive shafts 28, where the drive shafts 28 can rotate supporting material 12 in and out of contacting liquid 14, for example.

Embodiments can also include a liquid reservoir 30, mister, water dripper, or any other suitable component or mechanism that can keep algae, which can be attached to support material 12, moist. Embodiments can include any suitable scraping system, vacuum system, or mechanism for harvesting algal cells 18 from supporting material 12. It will be appreciated that the system can include one or a plurality of rollers that can be guide and support supporting material 12 in addition to drive shafts 28.

In an exemplary embodiment, harvesting system 22 is a generally triangle-shaped mechanized harvesting device. Such a configuration can be beneficial in maximizing the amount of sunlight or light to which algal cells 18 are exposed. However, versions of the system can be designed, for example, in any configuration that includes a sunlight capture part 32 that can be exposed to air and sunlight, and a nutrient capture part 34 that can be submerged into a nutrient solution or contacting liquid 14. In one exemplary embodiment, the algae can be rotated within an enclosed greenhouse 40 (FIGS. 3 and 4) having an increased carbon dioxide concentration relative to the atmosphere, which may improve the growth rate of the algae.

It will be appreciated that, in a first position, supporting material 12 can have a portion that is in sunlight capture part 32 and a portion that is in nutrient capture part 34, where rotation of supporting material 12 to a second position can result in different regions corresponding to sunlight capture part 32 and nutrient capture part 34. Such movement of supporting material 12 can, for example, beneficially transition algal cells 18 from a nutrient rich liquid to a region with sunlight and carbon dioxide content higher than the outside atmosphere. As will be shown in more detail herein, a substantially vertical design is contemplated, which may be the simplest and most cost efficient design, because such a system may minimize the amount of wasted space and may maximize the amount of algae produced in a small area. Alternative designs can include a straight vertical reactor, a reactor that is straight but slightly angled to provide more surface area for sunlight to hit, a cylindrical reactor, or a square shaped reactor.

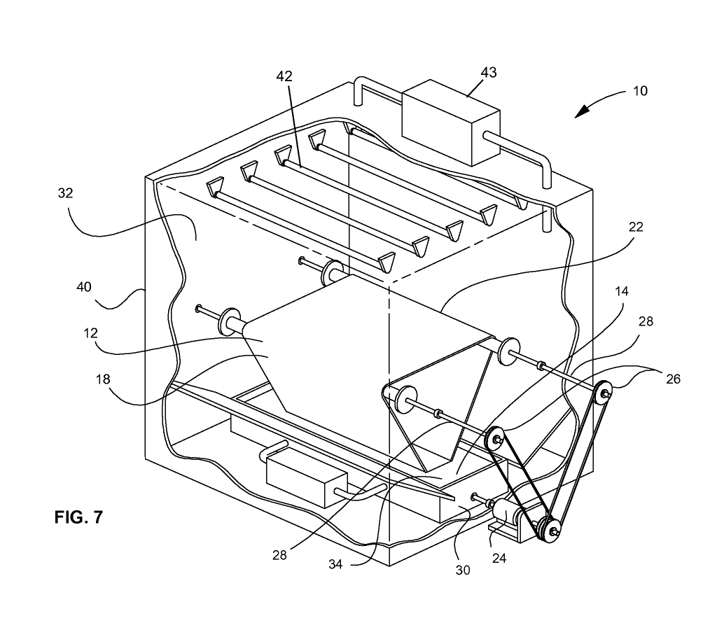

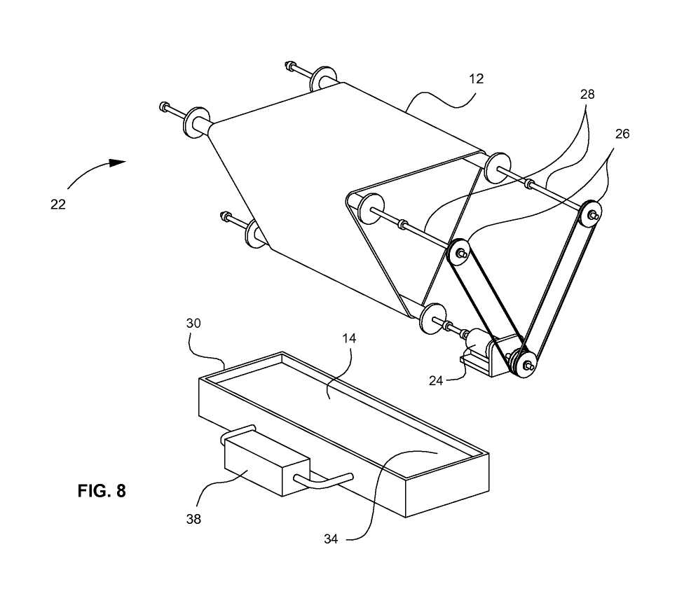

FIG. 8 illustrates harvesting system 22 and liquid reservoir 30 shown in an exploded view. Generally triangle-shaped algal growth and mechanized harvesting system 22 includes supporting material 12 that is movable or removable relative to liquid reservoir 30. Supporting material 12, and any associated components such as drive shafts 28 and gear system 26, can be movable or removable for cleaning, replacement, harvesting, adjustment, or the like. It will be appreciated that such movement can be manual or can be automated if desirable.

In an exemplary embodiment, liquid reservoir 30 contains contacting liquid 14 having a first chemical or fluid makeup, where supporting material 12 can be lifted or otherwise transitioned from liquid reservoir 30 into a second liquid reservoir having a second liquid having a different chemical or fluid makeup from contacting liquid 14. In this manner, supporting material 12 retaining algal cells 18 can be dipped or transitioned into a variety of fluids or materials that may maximize algal growth or otherwise provide a benefit. Such a system can be repeated or adjusted as appropriate. In an alternate exemplary embodiment, supporting material 12 can be lifted or moved from liquid reservoir 30 and transitioned to a harvesting station. In one exemplary embodiment, harvesting can take place while supporting material 12 is positioned within liquid reservoir 30.

Still referring to FIG. 8, liquid reservoir 30 includes a pump 38 or any other suitable actuator or fluid control. Pump 38 circulates contacting liquid 14, which may improve the growth of algal cells 18 and the efficiency of the overall system. It will be appreciated that pump 38 can be an electric pump, a wheel, a paddlewheel, or can have any other suitable configuration to create any desirable flow pattern. It will be appreciated that pump 38 can also heat, cool, or otherwise adjust the conditions associated with contacting liquid 14. Pump 38 can also be configured for the delivery of supplemental nutrients, such as supplemental fluids delivered at pre-specified times, where such delivery can be manual or automated. It will be appreciated that pump 38, and any other suitable components, can be associated with a computer, controller, or microcontroller that can be programmed to provide any suitable automated functionality.

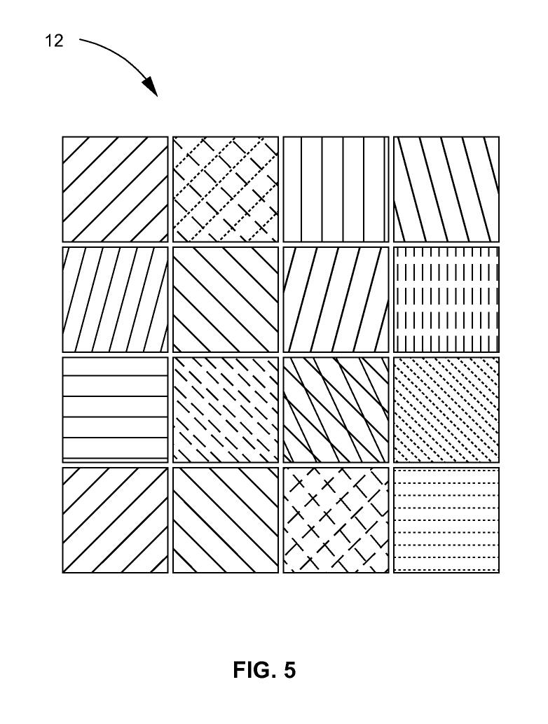

FIG. 5 illustrates a number of suitable patterns that may be utilized for supporting material 12. Supporting material 12 may be any suitable material for attaching algal cells 18, such as any suitable flexible fabric, that can be used with the systems and methods described herein to grow any suitable material. For example, the microalga Chlorella, such as Chlorella vulgaris can be grown on materials such as, muslin cheesecloth, aramid fiberglass, porous PTFE coated fiberglass, chamois, vermiculite, microfiber, synthetic chamois, fiberglass, burlap, cotton duct, velvet, TYVEK®, poly-lactic acid, abrased poly-lactic acid, vinyl laminated nylon, polyester, wool, acrylic, lanolin, woolen, cashmere, leather, silk, lyocell, hemp fabric, SPANDEX®, polyurethane, olefin fiber, polylactide, LUREX®, carbon fiber, and combinations thereof. Supporting material 12 or associated material can include rubbers such as, for example, buna-n Rubber, butyl rubber, ECH rubber, EPDM rubber, gum rubber, polyethylene rubber, latex rubber, neoprene rubber, polyurethane, santoprene rubber, SBR rubber, silicone rubber, vinyl rubber, VITON® fluoroelastomer, aflas, fuorosilicone, or combinations thereof.

Supporting material 12 or associated material can include plastics such as, for example, PETG, acrylic, cast acrylic, cellulose, polycarbonate, LDPE, PLA, PVC, ABS, polystyrene, HDPE, polypropylene, UHMW, delrin, acetal resin, nylon, cast nylon, CPVC, rexolite polystyrene, noryl PPO, polyester, PVDF, polysulfone, radel PPSU, ulrem PEI, FEP, PPS, PEEK, PFA, torlon PAI, reflon PTFE, polyimide, antistatic polycarbonate, antistatic cast acrylic, conductive ABS/PVC, antistatic acetal, atatic-dissipative UHMW, conductive UHMW, antistatic PTFE, glass-filled polycarbonate, strengthened acrylic, strengthened PVC, glass-filled nylon, glass-filled acetal, glass-filled UHMW, glass-filled PTFE, and combinations thereof. Supporting material 12 and associated materials can include metals such as, for example, aluminum, steel, cast iron, tungsten carbide, tungsten alloy, stainless steel, nickel, titanium, copper, brass, bronze, lead, tin, zinc, casting alloys, or combinations thereof. Any suitable material for supporting material 12 and associated materials is contemplated including ceramic, felt, fiberglass, foam, foam rubber, foam plastic, glass, leathers, carbon fiber, wire cloth, or the like.

The material associated with supporting material 12 can have a high surface roughness, high hydrophobicity, and high positive surface charge in one embodiment. It will be appreciated that any suitable texture, surface treatment, hybrid material, or the like is contemplated. Supporting material 12, belt, sheet, or band can be altered, modified, or changed with heat, abrasion, applying another material, chemically treating, applying a charged molecule, applying a polar molecule, or combinations thereof.

Supporting material 12 can be reinforced by attaching a high strength and slowly degradable second layer of material to a cell growth material. In this example, photobioreactor 10 can be configured such that the high strength material comes in contact with components such as rollers, drive shafts 28, and the like. Such a configuration may help avoid the wearing off of the cell growth material during operation of photobioreactor 10. Suitable materials can include materials that are not easily degraded by water and microbes such as plastic, rubber, TYVEK®, or other slowly degrading materials. Additionally, materials, adhesives, chemicals, or the like can be sprayed onto or otherwise provided on supporting material 12 to facilitate algal attachment. It will be appreciated that any suitable number of layers of material is contemplated.

It will be appreciated that any suitable algal cells 18 (including cyanobacteria) as well as fungal strains, such as strains that can be used in aquaculture feed, animal feed, nutraceuticals, or biofuel production can be used. Such strains can include Nannochloropsis sp., which can be used for both biofuel production and aquacultural feed, Scenedesmus sp., a green microalga that can be used in wastewater treatment as well as for fuel production feedstock, Haematococcus sp., which can produce a high level of astaxanthin, Botryococcus sp., a green microalga with high oil content, Spirulina sp., a blue-green alga with high protein content, Dunaliella sp., a green microalga containing a large amount of carotenoids, and/or a group of microalgae species producing a high level of long chain polyunsaturated fatty acids can include Arthrospira, Porphyridium, Phaeodactylum, Nitzschia, Crypthecodinium, and Schizochytrium. Any suitable parameter, including gaseous phase CO2 concentration, harvesting frequency, the rotation speed of the RAB reactor, the depth of the biofilm harvested, the ratio of submerged portion to the air-exposure portion of the RAB reactor, or the gap between the different modules of the RAB system can be optimized for any suitable species. It will be appreciated that the listed genus and species are described by way of example and additions and combinations are contemplated.

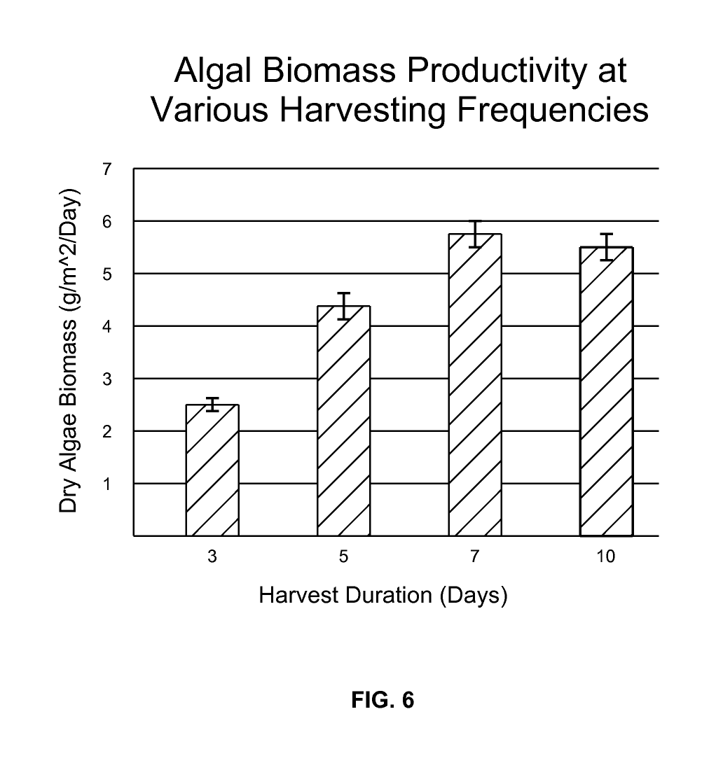

FIG. 6 illustrates an exemplary harvesting productivity based on the harvesting duration in days using the systems of the present invention. Any suitable harvesting schedule may be employed with the systems and methods of the present invention. The mechanism of harvesting biomass from the biofilm can be, for example, scraping, high pressure air, vacuum, or combinations thereof. Biomass productivity may vary by species and any suitable harvesting time is contemplated to maximize such productivity. For example, as shown in FIG. 6, algae was grown on a RAB system of the present invention and then harvested at different durations. The dry algae biomass productivity of the specific species for which data is illustrated varies as a function of harvesting time. As shown in FIG. 6, for Chlorella the optimal harvest frequency may be every 7 days. In exemplary embodiments, managing other parameters such as CO2 concentration and nutrient loading may also impact algal growth performance.

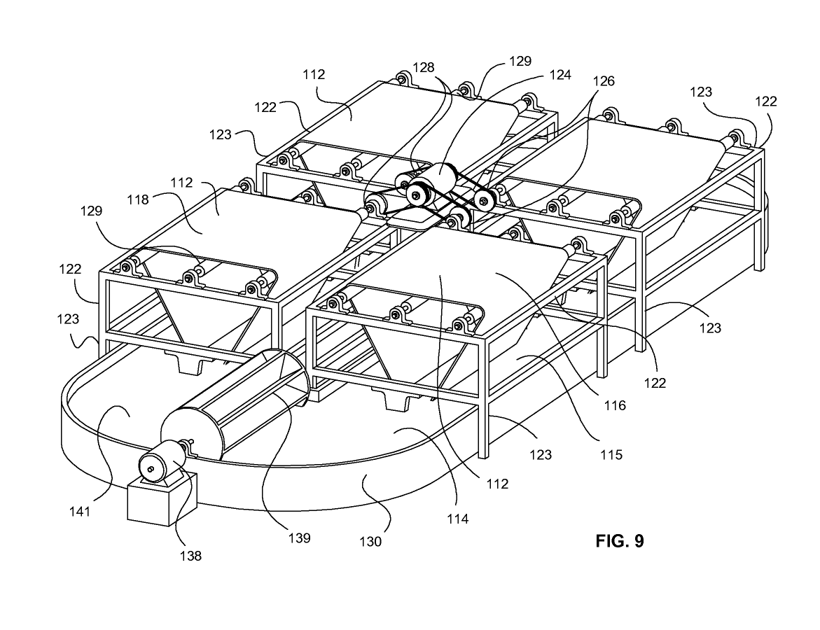

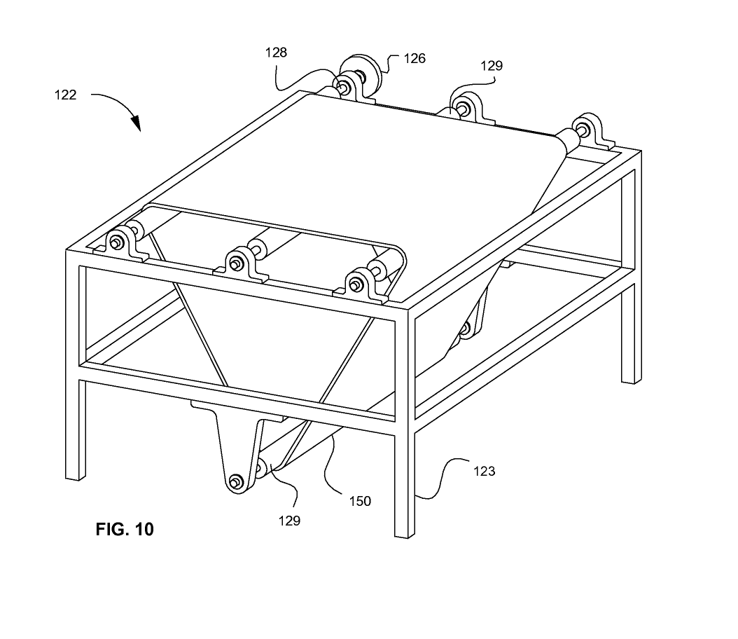

In one exemplary embodiment, as shown in FIGS. 9-11, multiple harvesting systems may be utilized with a single liquid reservoir to increase the overall algae harvested to enhance nutrient removal in accordance with the methods of the present invention. Referring to FIGS. 9-11, shown is an alternate embodiment of a revolving algal biofilm photobioreactor (RABP) 100 that can be used as algal treatment system 1006. In this example, algal cells 118 are attached to a solid surface of a supporting material 112 that can be rotated between a nutrient-rich liquid phase 115 and a CO2-rich gaseous phase 116 for alternative absorption of nutrients and carbon dioxide. The algal biomass can be harvested by scraping the biomass from the attached surface with a harvesting mechanism such as a squeegee, vacuum, reaper, or the like. Photobioreactor 100 may require only a small amount of water for operation, relative to existing methods, where only a bottom portion 150 (FIG. 10) of an algal growth unit or mechanized harvesting unit 122 is immersed in a contacting liquid 114.

Photobioreactor 100 includes a plurality of mechanized harvesting units 122, each having frames 123 that can be positioned in a raceway 130 containing contacting fluid 114. Exemplary embodiments can include a large number of mechanized harvesting units such that photobioreactor 100 can be scaled up to an industrial scale. For example, a single raceway could have 20, 50, 100, or more mechanized harvesting units 122. In an exemplary embodiment, mechanized harvesting units 122 are retrofitted onto an existing raceway pond system. Embodiments of mechanized harvesting units 122 can be placed, for example, in any suitable fluid retaining location or device.

Embodiments of photobioreactor 100 include a drive motor 124 and a gear system 126 that can rotate one or more drive shafts 128, where drive shafts 128 can correspondingly rotate supporting material 112, such as a flexible sheet material for growing algal cells 118. Photobioreactor 100 can include one or more rollers 129 that support and guide supporting material 112. Supporting material 112 can be rotated into contact with the contacting liquid 114, which allows algal cells 118 to attach to supporting material 112. Drive motor 124 includes gear system 126 or a pulley system that can actuate drive shafts 128, where drive shafts 128 can rotate supporting material 112 into and out of contacting liquid 114. Embodiments can also include raceway 130, a mister, a water dripper, or any other suitable component or mechanism that can keep algae attached to support material 112 moist.

Embodiments can include any suitable scraping system, vacuum system or mechanism for harvesting algal cells 118 from supporting material 112. It will be appreciated that drive motor 124 can be associated with a plurality of mechanized harvesting units 122 or, in an alternate embodiment, each mechanized harvesting unit can be associated with an independent motor, gear, and/or drive shaft system. It may be efficient to operate one or more of the mechanized harvesting units 122 on the same schedule, but it may also be advantageous to operate some or all of mechanized harvesting units 122 on different schedules. For example, in one embodiment, one of harvesting units 122 exposed to natural light can be associated with a light sensor and controller such that the rotation speed of supporting material 112 is optimized relative to the available light. In such an example, mechanized harvesting units 122 in the same facility may have different, or slightly different environmental conditions, where operating each mechanized harvesting unit 122 independently may substantially optimize the overall system.

FIG. 10 illustrates one of harvesting units 122. In this example, mechanized harvesting unit 122 has a generally triangle-shaped configuration supported by frame 123. It will be appreciated that frame 123 can be constructed from any suitable material, such as metal, and can have any suitable configuration. Frame 123 can be substantially level relative to a flat surface, can be stepped, or otherwise shaped to accommodate an incline or an uneven surface. Frame 123 can include telescoping components, such as telescoping legs, which may allow the frame to be used effectively as a retrofit in existing raceways, for example. Frame 123 can be stackable or can be coupled in a side-by-side fashion with other frames in an interlocking manner such that a plurality of mechanized harvesting systems 122 can be connected to form photobioreactor 100. Such a modular system may allow for a few mechanized harvesting system designs to be used in a wide variety of locations and situations.

Mechanized harvesting units 122 can be associated with raceway 130 in any suitable manner or configuration. For example, each of mechanized harvesting units 122 can be integral with or permanently affixed to raceway 130. In an alternate exemplary embodiment, each mechanized harvesting unit 122 can be selectively removable or adjustable relative to raceway 130, where mechanized harvesting unit 122 can be removed for cleaning, harvesting, replacement, upgrade, or the like.

FIG. 11 illustrates an exemplary raceway that may be employed as raceway 130. Raceway 130 can have any suitable shape or configuration. In one example, raceway 130 includes a motor 138 that can be configured to drive a paddlewheel 139. Paddlewheel 139 is configured to create a current or flow within raceway 130 that may facilitate the growth of algal cells 118. It will be appreciated that raceway 130, motor 138, and paddlewheel 139 are shown by way of example only, and any suitable mechanism to provide a desirable flow or current in a suitable reservoir may be utilized in the methods of the present invention.

Raceway 130 can be open or otherwise exposed to light such that algae can easily grow within raceway 130. Raceway 130 can have a region 141 that can be exposed to light and may not contain a mechanized harvesting unit, where region 141 is used to cultivate or grow a supply of algal cells 118 within raceway 130. Providing region 141, where region 141 can have any suitable shape or configuration, may make the system self-sustaining and may reduce the likelihood that the system needs to be seeded or re-seeded with algal cells.

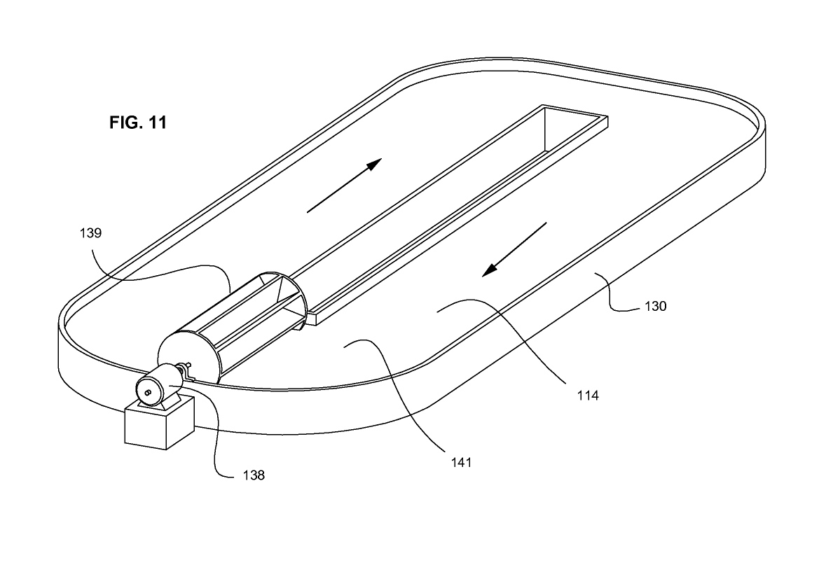

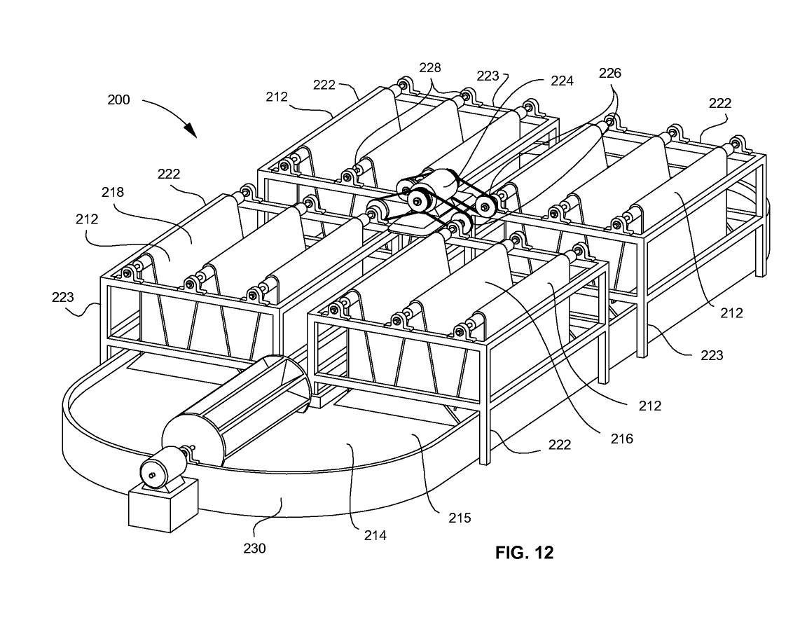

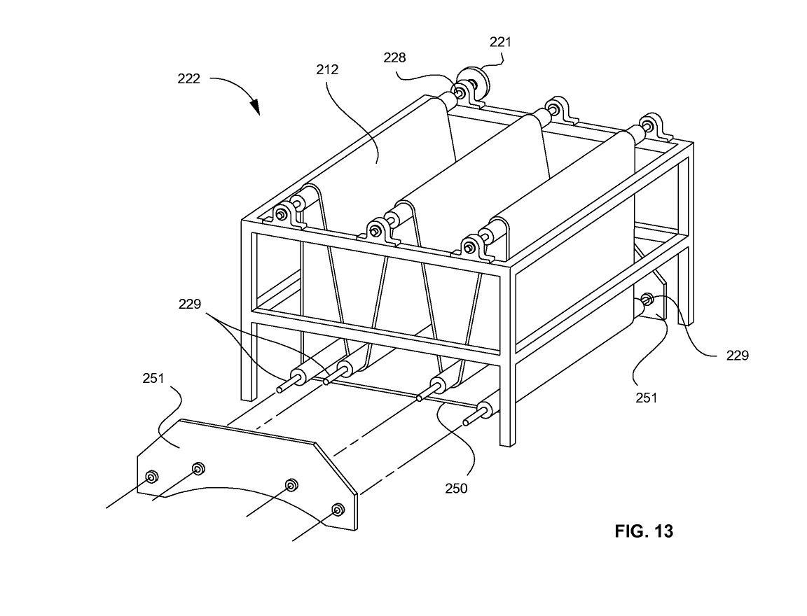

In some alternate examples, as shown FIGS. 12 and 13, a photobioreactor with multiple harvesting units, each unit having a sheet for growing algae that may be introduced into a contacting liquid at a number of points along the sheet simultaneously, may be utilized to further enhance the overall productivity of the system. FIGS. 12 and 13 show an alternate embodiment of a revolving algal biofilm photobioreactor (RAB) 200 that can be used as algal treatment system 1006. In this example, algal cells 218 are attached to a solid surface of a supporting material 212 that can be rotated between a nutrient-rich liquid phase 215 and a CO2-rich gaseous phase 216 for alternative absorption of nutrients and carbon dioxide. The algal biomass can be harvested by scraping the biomass from the attached surface with a harvesting mechanism such as a squeegee, vacuum, reaper, or the like. Photobioreactor 200 requires only a small amount of water for operation, relative to existing methods, where only a bottom portion 250 (FIG. 13) of an algal growth unit or mechanized harvesting unit 222 is immersed in a contacting liquid 214.

In this example, photobioreactor 200 includes one or more mechanized harvesting units 222, each harvesting unit 222 having a frame 223, which can be positioned in a raceway 230 containing contacting liquid 214. Example embodiments can include a large number of mechanized harvesting units 222 such that photobioreactor 200 can be scaled up to an industrial scale. For example, raceway 230 could have 20, 50, 100, or more mechanized harvesting units 22. In an exemplary embodiment, mechanized harvesting units 222 can be retrofitted onto an existing raceway pond system. Embodiments of mechanized harvesting units 222 can be placed, for example, in any suitable fluid retaining location or device.

Embodiments of photobioreactor 200 can include a drive motor 224 and a gear system or pulley system 226 that can rotate one or more drive shafts 228, where drive shafts 228 can correspondingly rotate supporting material 212, such as a flexible sheet material for growing algal cells 218. Photobioreactor 200 includes one or more rollers 229 that can support and guide supporting material 112. Supporting material 212 can be rotated into contact with contacting liquid 214, which allows algal cells 218 to attach to supporting material 212. Drive motor 224 includes gear system or pulley system 226 that can actuate drive shafts 228, where drive shafts 228 can rotate supporting material 212 into and out of the contacting liquid 214. Embodiments can also include a raceway 230, a mister, a water dripper, or any other suitable component or mechanism that can keep algae attached to support material 212 moist.

Embodiments can include any suitable scraping system, vacuum system or mechanism for harvesting algal cells 218 from supporting material 212. It will be appreciated that drive motor 224 can be associated with a plurality of mechanized harvesting units 222 or, in an alternate embodiment, each mechanized harvesting unit 222 can be associated with an independent motor, gear, and/or drive shaft system. It may be efficient to operate one or more of mechanized harvesting units 222 on the same schedule, but it may also be advantageous to operate some or all of mechanized harvesting units 222 on different schedules. For example, in one embodiment, one or mechanized harvesting unit 222 is exposed to natural light and can be associated with a light sensor and controller such that the rotation speed of supporting material 212 is optimized relative to the available light. In such an example, mechanized harvesting units 222 in the same facility may have different, or slightly different environmental conditions, where operating each mechanized harvesting unit 222 independently may substantially optimize the overall system.

In this exemplary embodiment, mechanized harvesting unit 222 has a generally wave-shaped configuration supported by frame 223. It will be appreciated that frame 223 can be constructed from any suitable material, such as metal, and can have any suitable configuration in accordance with embodiments described herein. In this example, supporting material 212 of mechanized harvesting unit 222 can have a substantially wave-shaped configuration as best illustrated in FIG. 13. Supporting material 212 is a contiguous band of material and can be wound about drive shafts 228 or rollers 229 such that any suitable configuration is created. It is contemplated that supporting material 212 can be a long, contiguous band of material having multiple peaks and valleys, as illustrated in FIGS. 12 and 13.

As illustrated in FIG. 13, a portion of supporting material 212 can also pass along bottom portion 250 of mechanized harvesting unit 222. It will be appreciated that a single long band and a plurality of bands having any suitable relationship or configuration are contemplated. In an exemplary embodiment, drive shafts 228 or rollers 229 can be adjusted such that different configurations can be created using the same frame 223. Such an interchangeable system may be beneficial in that certain configurations may be beneficial to particular species of algal cells 218. An interchangeable system may also allow for different environmental conditions, uses, or use on a wide range of scales. Any other suitable component, such as a plate 251 can be provided to secure components, such as rollers 229, in a desired configuration.

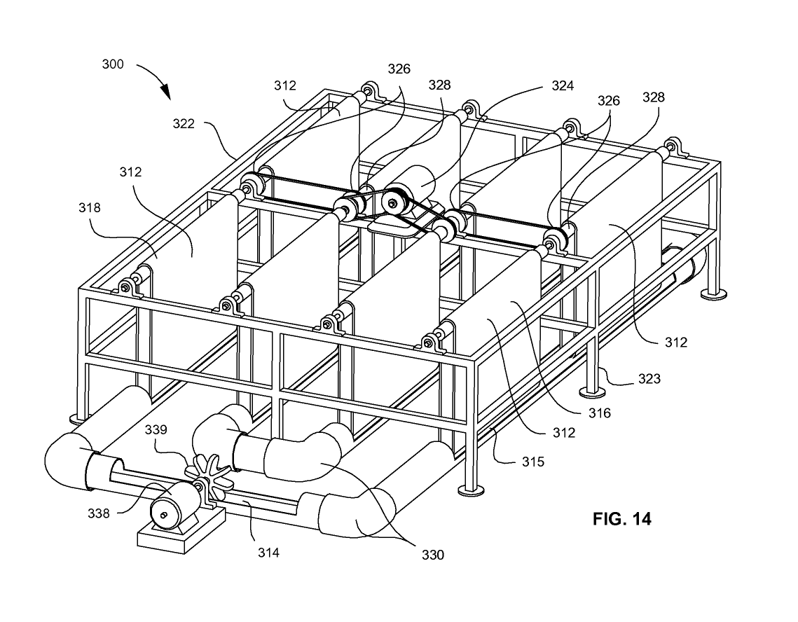

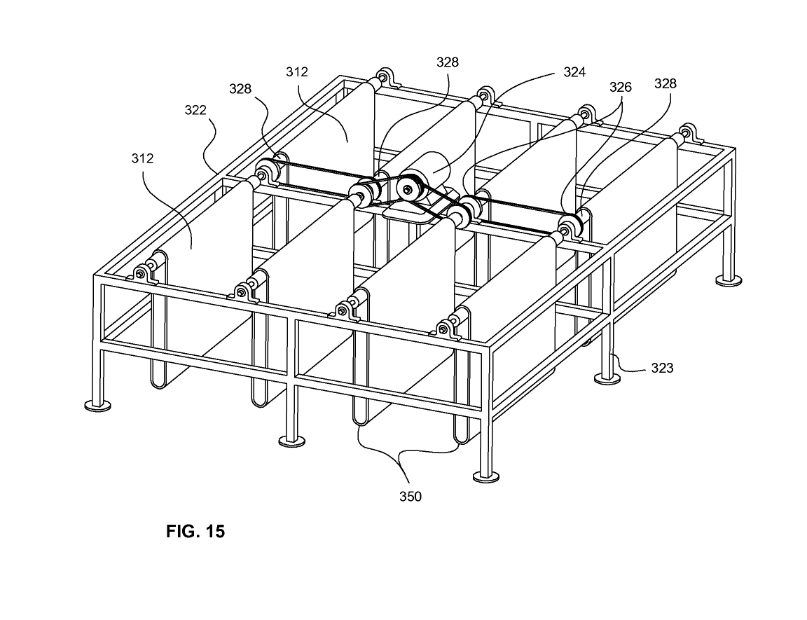

FIGS. 14-16 show an alternate embodiment of a revolving algal biofilm photobioreactor (RAB) 300 that may be employed as algal treatment system 1006. In this example, a plurality of harvesting units on a single frame are utilized with a serpentine trough that increases the overall efficiency of the system. In this example, algal cells 318 can be attached to a solid surface of one or a plurality of supporting materials 312 that can be rotated between a nutrient-rich liquid phase 315 and a CO2-rich gaseous phase 316 for alternative absorption of nutrients and carbon dioxide. The algal biomass can be harvested by scrapping the biomass from the attached surface with a harvesting mechanism such as a squeegee, vacuum, reaper, or the like. Photobioreactor 300 requires only a small amount of water for operation, relative to existing methods, where only a bottom portion 350 (FIG. 15) of an algal growth unit or mechanized harvesting unit 322 is immersed in a contacting liquid 314.

Photobioreactor 300 includes a frame 323, which can be positioned in a trough system 330 containing contacting fluid 314. Exemplary embodiments can include a large number of mechanized harvesting units 322 such that photobioreactor 300 can be scaled up to an industrial scale. For example, single trough system 330 could have 20, 50, 100, or more mechanized harvesting units 322 or independent supporting material units. In an exemplary embodiment, mechanized harvesting units 322 can be retrofitted onto an existing raceway pond system. Embodiments of mechanized harvesting units 322 can be placed, for example, in any suitable fluid retaining location or device.

FIG. 16 illustrates trough system 330 that may be utilized with photobioreactor 300. It will be appreciated that trough system 330 is shown by way of example only, where any suitable tubing, configuration, or construction is contemplated. In this example, trough system 330 has a serpentine configuration such that trough system 330 forms a substantially closed circuit for fluid flow. Trough system 330 can have any suitable shape, where trough system 330 can have interchangeable parts such that different configurations can be created by a user. Trough system 330 includes a number of apertures 360 and closed sections 362, as shown in FIG. 16, where apertures 360 are configured to accept supporting materials 312. In one embodiment, apertures 360 are associated with a closure when not in use. Alternatively, apertures 360 can be used in sunlight or well-lit areas to help facilitate algal growth in contacting liquid 314. Trough system 330 can be associated with a motor 338 and a paddlewheel 339 configured to create a fluid dynamic or current flow in trough system 330. In one embodiment, one or more paddlewheels 339, or other actuators, can be positioned in apertures 360.

Referring again to FIGS. 14 and 15, exemplary embodiments of photobioreactor 300 can include a drive motor 324 and a gear system or pulley system 326 that can rotate one or more drive shafts 328, where drive shafts 328 can correspondingly rotate supporting materials 312, such as a flexible sheet material for growing algal cells 318. Photobioreactor 300 also includes one or more of rollers that can support and guide supporting materials 312 or, as illustrated in FIG. 15, the bottom of supporting materials 312 can hang freely in a substantially vertical configuration.

Supporting materials 312 can be rotated into contact with contacting liquid 314, which can allow algal cells 318 to attach to supporting materials 312. Drive motor 324 includes gear system 326 or a pulley system that can actuate drive shafts 328, where drive shafts 328 can rotate supporting materials 312 into and out of contacting liquid 314. Embodiments can also include trough system 330, a mister, a water dripper, or any other suitable component or mechanism that can keep algae attached to supporting materials 312 moist.

Embodiments can include any suitable scraping system, vacuum system, or mechanism for harvesting algal cells 318 from supporting materials 312. It will be appreciated that drive motor 324 can be associated with a plurality of mechanized harvesting units 322 or supporting materials 312. In an alternate embodiment, each of supporting materials 312 can be associated with an independent motor, gear or pulley, and/or drive shaft system. It may be efficient to operate one or more supporting materials 312 on the same schedule, but it may also be advantageous to operate some or all of supporting materials 312 on different schedules. For example, in one embodiment, one of supporting materials 312 is exposed to natural light and is associated with a light sensor and controller such that the rotation speed of the supporting material 312 is optimized relative to the available light. In such an example, one or more of supporting materials 312 in the same facility may have different, or slightly different environmental conditions, where operating each one or a plurality of supporting materials independently may substantially optimize the overall system.

In this example, mechanized harvesting unit 322 has a generally vertically-shaped configuration of supporting materials 312 that can be supported by frame 323. It will be appreciated that frame 323 can be constructed from any suitable material, such as metal, and can have any suitable configuration in accordance with embodiments described herein. Each of supporting materials 312 can be a contiguous band of material, strips, ropes, slats, ribbons, plates, scales, overlapping material, or the like, and can be wound about drive shafts 328 or rollers such that any suitable configuration can be created. It is contemplated that supporting material 312 can be a long, contiguous band of material having multiple peaks and valleys, or can be separate units as illustrated in FIG. 15. It will be appreciated that a single long band and a plurality of bands having any suitable relationship or configuration are contemplated.

In some exemplary embodiments, the harvesting units described may also include a mechanism, such as a vacuum system, for harvesting algal cells from the harvesting unit. Referring to FIG. 17, an exemplary embodiment of an algal growth system or mechanized harvesting unit 422 is shown that may be employed in any of the exemplary embodiments disclosed herein and utilized in algal treatment system 1006. In this example, algal cells 418 are attached to a solid surface of a supporting material 412. Embodiments of mechanized harvesting unit 422 include a drive motor, and a gear system 426 that can rotate one or more drive shafts 428, where drive shafts 428 can correspondingly rotate supporting material 412, such as a flexible sheet material. Embodiments of mechanized harvesting unit 422 can include a harvesting system 480 that can include any suitable manual or automatic harvesting mechanism and/or a harvesting reservoir 482.

In this example, harvesting system 480 includes a vacuum system 484 and a scraper 486 for harvesting algal cells 418 from supporting material 412. Scraper 486 is coupled with a motor 488 and a pulley system or actuator 490 such that scraper 486 can be selectively engaged with supporting material 412. Motor 488 is associated with a controller 492 such that harvesting system 480 can be programmed to scrape, harvest, or perform any other suitable function automatically or on a predetermined schedule.

FIG. 18 illustrates another exemplary embodiment of an algal growth system 522 that includes an integrated paddle 522 and a textured supporting material. This embodiment advantageously does not require a pumping mechanism to agitate the contacting liquid. In this exemplary embodiment, algal growth system includes a supporting material 512 that includes one or more ribs 596, can be finned, or otherwise textured such that a pump is not needed to agitate an associated contacting liquid, where rotation of textured supporting material 512 can sufficiently agitate or otherwise create a desirable fluid dynamic. Algal growth system 522 also includes integrated paddle 598 that can be positioned within a contacting liquid such that rotation of supporting material 512 correspondingly rotates integrated paddle 598. In alternate embodiments, supporting material 512 can include flexible regions and rigid regions, can be a hinged belt, can have removable sections, or can otherwise be suitably configured. For example, in one embodiment, strips of material can be attached to a rotating belt with a hook and loop fastener, where such strips can be pulled off of the rotating belt during harvesting and replaced when harvesting is complete.

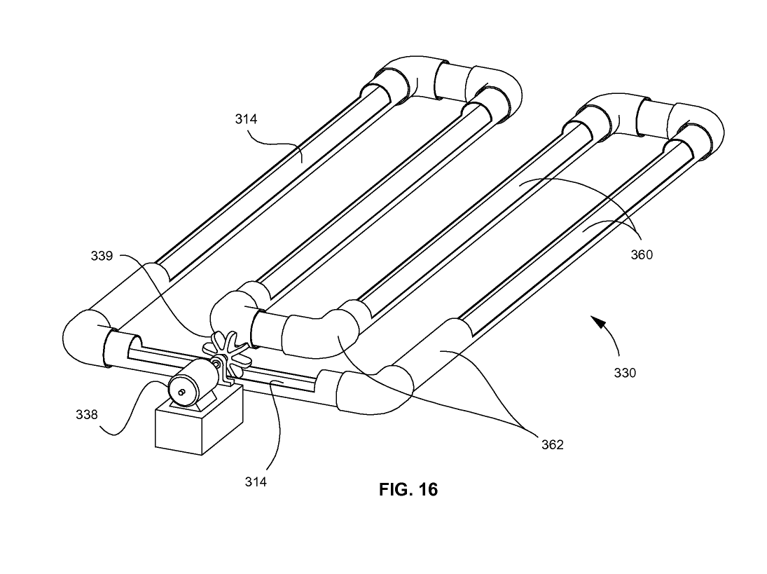

FIG. 19 illustrates an exemplary photobioreactor system 600 that provides a growth location prior to the harvesting units. This embodiment may allow for spiking with a particular microorganism prior to treatment to allow for enhanced removal of specific nutrients as described with respect to the methods of the present invention below. In this example, photobioreactor system includes a first location 602 for growing algal cells. The algal cells are then transported via a channel 604, or other suitable connection, to a second location 606, such as to a photobioreactor provided in accordance with the various embodiments described herein. First location 602 is fluidly coupled to the second location 606 or, in an alternate embodiment, first location 602 is a portable bioreactor that can be selectively connected to second location 606 as needed.

Referring again to FIG. 1, algal treatment system 1006 is located to deliver treated wastewater to wastewater treatment lagoons 1008. Wastewater treatment lagoons 1008 are pond-like bodies of water or basins designed to receive the treated wastewater from algal treatment system 1006 and to hold and provide further treatment to the wastewater for a predetermined period of time. Wastewater treatment lagoons 1008 are constructed using methods known in the art. Wastewater treatment lagoons 1008 may include, by way of example, polishing, stabilization, and maturation ponds located in parallel or in series. Wastewater treatment lagoons 1008 provide for additional nutrient removal from the treated wastewater from algal treatment system 1006. The pretreatment in algal treatment system 1006 allows wastewater treatment lagoons 1008 to provide an effluent that meets higher standards for nutrient removal, such as ammonia, total nitrogen, total phosphorous, and/or COD for example. Wastewater treatment lagoons 1008 provide the effluent flow of further treated wastewater to the treated water receiving body 1012, such as a creek or river, to return the treated wastewater to the environment.

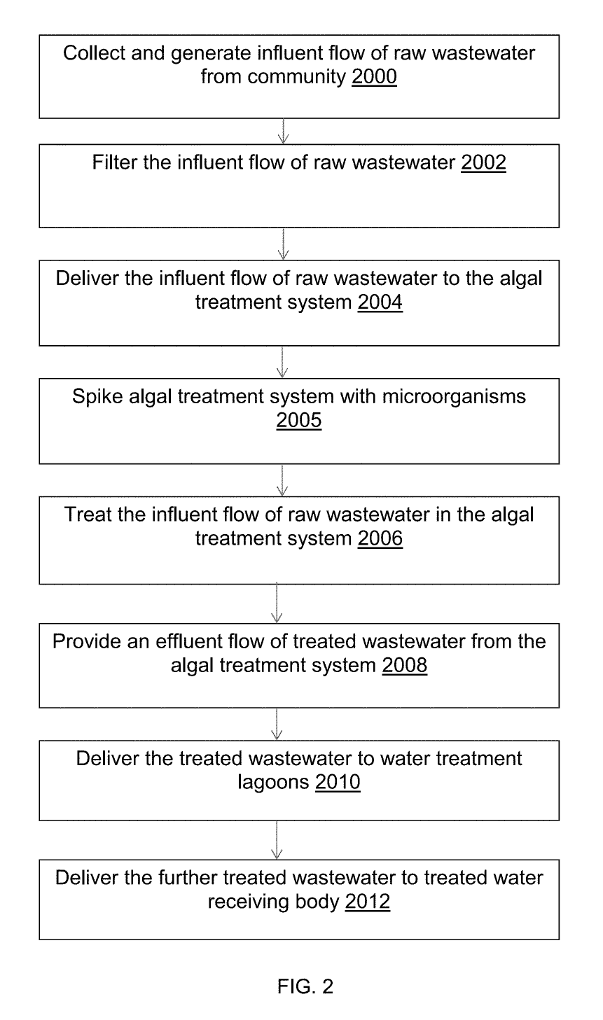

An exemplary method of treating wastewater of the present invention will now be described with respect to FIGS. 1 and 2. In step 2000 raw wastewater is collected and an influent flow of raw wastewater is generated from community 1002 through sewage collection systems. The influent flow of raw wastewater is generated to be delivered to water treatment system 1004 including algal treatment system 1006 and wastewater treatment lagoons 1008. For purposes of this disclosure, the term raw wastewater may include some level of solid separation prior to being treated in water treatment system 1004.

Next, optionally in step 2002 the influent flow of wastewater is filtered prior to being introduced to water treatment system 1004. By way of example, the influent flow of raw wastewater may be introduced to additional pre-treatment system 1010, such as a solid separation pit or a filtering mechanism to remove solids from the raw wastewater prior to treatment. In one example, pre-treatment system 1010 includes a filtering system comprising a filter between about 100 nm and 10 cm for the removal of solids from the raw wastewater.

In step 2004, the influent flow of raw wastewater is delivered to algal treatment system 1006 of water treatment system 1004 for treatment. The influent flow is delivered to algal treatment system 1006 prior to entering wastewater treatment lagoons 1008. In this manner, the heat of the flowing wastewater is retained as opposed to being dissipated in the larger treatment lagoons. In one example, algal treatment system 1006 is located upstream from waste wastewater treatment lagoons 1008 to provide the algal treatment prior to the influent flow of raw wastewater entering wastewater treatment lagoons 1008. This allows for the treatment to occur at higher temperatures. In one example, the treating is carried out at a minimum of between 40-70 degrees Fahrenheit. In yet another example, the treating is carried out at a minimum of between 50-60 degrees Fahrenheit. Algal treatment system 1006 may be located in a greenhouse structure to better retain the heat of the influent wastewater during treatment.

In step 2005, the algal treatment system 1006 is spiked with algae, or other microorganism, prior to treating the influent flow or raw wastewater to enhance one or more of ammonia, total nitrogen, or total phosphorus removal during the subsequent treatment step. Suitable algal cells (including cyanobacteria) as well as fungal strains, such as strains that can be used in aquaculture feed, animal feed, nutraceuticals, or biofuel production can be used in algal treatment system 1006. Such strains can include Nannochloropsis sp., Scenedesmus sp., Haematococcus sp., Botryococcus sp., Dunaliella sp., and/or a group of microalgae species including Arthrospira, Porphyridium, Phaeodactylum, Nitzschia, Crypthecodinium and Schizochytrium. It will be appreciated that the listed genus and species are described by way of example and additions and combinations are contemplated. A specific group of microorganisms may be spiked in algal treatment system in order to enhance ammonia and total nitrogen removal as is known in the art of wastewater treatment generally.

Next, in step 2006, the influent flow of raw wastewater is treated in algal treatment system 1006. Algal treatment system 1006 may be any wastewater treatment system that treats raw wastewater using a microalga based treatment for nutrient removal, such as hyper-concentrated cultures, immobilized cell systems, dialysis cultures, algal mats, or tubular photo-bioreactors. The treatment provides an effluent having at least one toxic element having a lower value than in the treated influent. In another example, algal treatment system 1006 is a revolving algal biofilm (RAB) treatment system as described in U.S. Pat. Nos. 9,932,549 and 10,125,341, the disclosures of which are hereby incorporated by reference in their entirety. Methods of treatment are also disclosed in U.S. Pat. Nos. 9,932,549 and 10,125,341 and are incorporated herein.

The raw wastewater is retained in the algal treatment system 1006 for a residence time. The residence time may be varied depending on the amount of pre-treatment required. In one example, the influent flow of raw wastewater has a residence time in the algal treatment system between about 0.8 hours and about 24 hours.

In step 2008, algal treatment 1006 provides an effluent flow of treated wastewater. The algal treatment system 1006 is utilized for nutrient removal including treatment for removing ammonia, total nitrogen and/or total phosphorous, as well as reducing the chemical oxygen demand of the raw wastewater. In one example, the treated wastewater has a level of ammonia below that of said raw wastewater. The level of ammonia in the treated wastewater is, by way of example, 44-65%, 65-85%, 70-90%, or 80-100% below that of raw wastewater delivered to algal treatment system 1006. The treated wastewater also has a chemical oxygen demand (COD) below that of the raw wastewater. For example, the COD of the treated wastewater may be between about 20% and about 60% below that of said raw wastewater. In one example, the treated wastewater also has levels of total nitrogen and/or total phosphorous below that of the raw wastewater.

In step 2010, the treated wastewater is delivered from algal treatment system 1006 to wastewater treatment lagoons 1008 or a mechanized biological treatment system for further treatment and nutrient removal as known in the art. In step 2012, the further treated water is delivered from wastewater treatment lagoons 1008 to treated water receiving body 1012, such as a creek or river, for receiving treated wastewater from wastewater treatment system 1004 to reenter the environment.

Another aspect of the present invention relates to a water treatment system. The water treatment system includes a harvestable algae biofilm treatment system positioned to receive an influent flow of raw wastewater from one or more sources. A wastewater treatment lagoon is coupled to the harvestable algae biofilm treatment system through one or more conduits to receive the treated wastewater from the harvestable algae biofilm treatment system.

### EXAMPLES

### Example 1

### Revolving Algal Biofilm (RAB) Treatment System

A pilot-study was performed in Dallas Center, Iowa at their municipal wastewater treatment lagoon facility. The pilot-scale RAB system used in this study is located in a 22 ft×8 ft enclosed car trailer that has been converted into a greenhouse structure. The trailer was located to treat the wastewater prior to entering the existing lagoon facility. This arrangement uses the heat in the warm wastewater to keep the algal reactor warm and thus, maintain maximum algal activity for nutrient absorption.

### Example 2

### Design and Operating Conditions

The pilot-scale RAB system with approximately 40 m² of belt surface area and 4.5 m² of footprint was located inside a greenhouse. The RAB system is placed into a liquid reservoir that has a 1,000 L working volume. The conveyor belts were rotated continuously and algae grew on the surface of the belts. Every 7 days, algae biomass was harvested from the belts.

The RAB system was started and ran continuously for almost six (6) months. During this period, the pilot-scale RAB system was operated at a series of daily influent flow rates at the following periods of time as follows:

| Time Period | Daily Influent Rate |
|---|---|
| Days 1-65 | 1,000 L/day (264 gal/day, HRT = 24.0 hr) |
| Days 66-70 | 2,000 L/day (529 gal/day, HRT = 12.0 hr) |
| Days 71-99 | 6,000 L/day (1,587 gal/day, HRT = 4.0 hr) |
| Days 100-111 | 30,000 L/day (7,936 gal/day, HRT = 0.8 hr) |
| Days 112-140 | 6,000 L/day (1,587 gal/day, HRT = 4.0 hr) |
| Days 141-159 | 12,000 L/day (3,174 gal/day, HRT = 2.0 hr) |
| Days 160-168 | 24,000 L/day (6,349 gal/day, HRT = 1.0 hr) |

Raw wastewater coming from Dallas Center sewers was first screened through a 5-mm filter and then pumped into the RAB system continuously at a designated HRT setting. At the same time, the effluent water was continuously pumped out of the RAB system liquid reservoir to maintain a constant 1,000 L liquid volume. Instruments logged several parameters every 30 minutes during the experiment, including: (1) water temperature of RAB system influent; (2) water temperature of RAB system effluent; (3) air temperature outside the greenhouse; (4) air temperature inside the greenhouse; and (5) flow rate through the RAB system.

The ammonia and COD concentrations in the influent (prior to entering the RAB system) and effluent (as it leaves the RAB system) were analyzed daily throughout the experiment. These concentration data were then used to calculate the nutrient removed (unit: % removed from the influent) and nutrient mass removal per RAB system module (unit: g/RAB module/day).

The total suspended solids (TSS) concentration for both the influent and effluent was also analyzed from May 10-20. During this period, the reactor flow rate was maintained at a very high level (6,349 gal/day, HRT=1 hr). This represented the “worst case scenario” as the lower flow rates will likely result in better TSS removal results.

During the testing period, total nitrogen (TN) and total phosphorus (TP) levels were also sampled and analyzed on certain days.

### Example 3

### Temperature Profiles

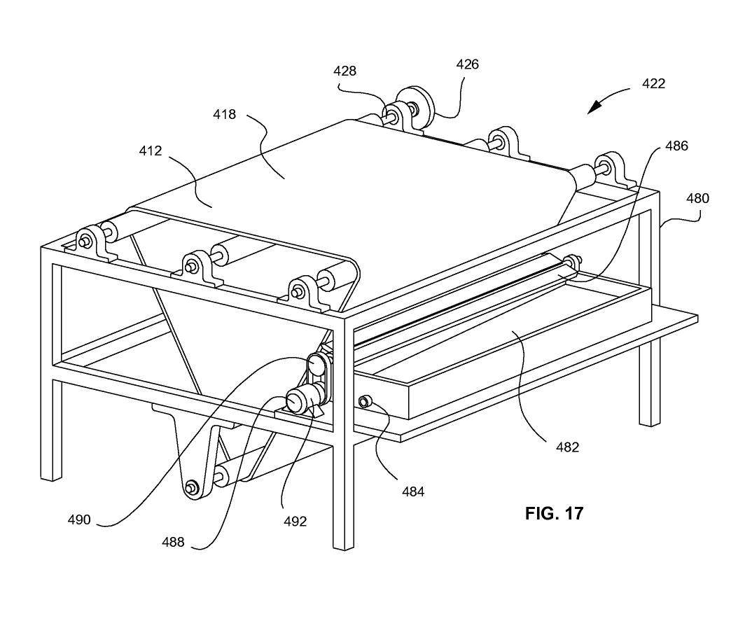

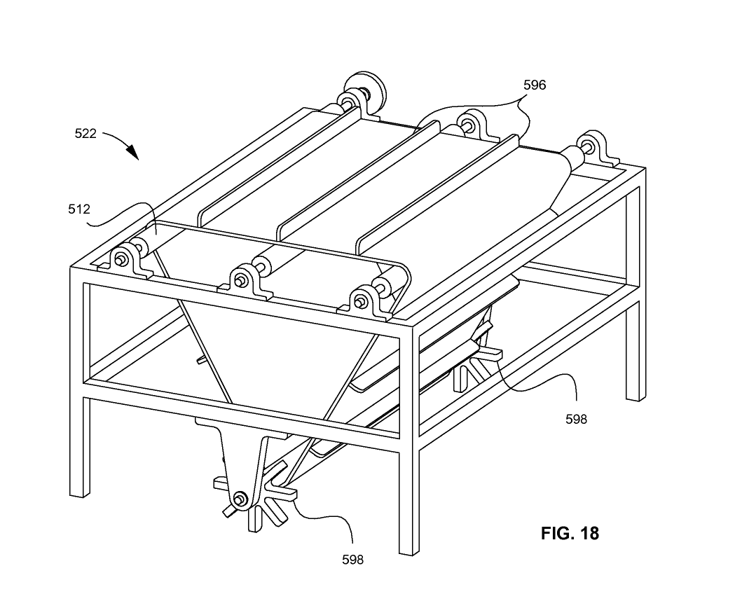

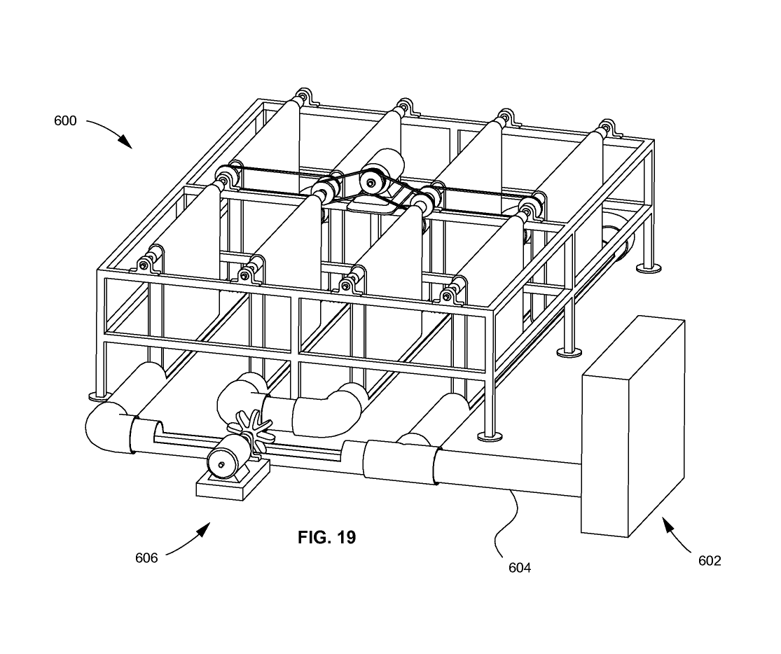

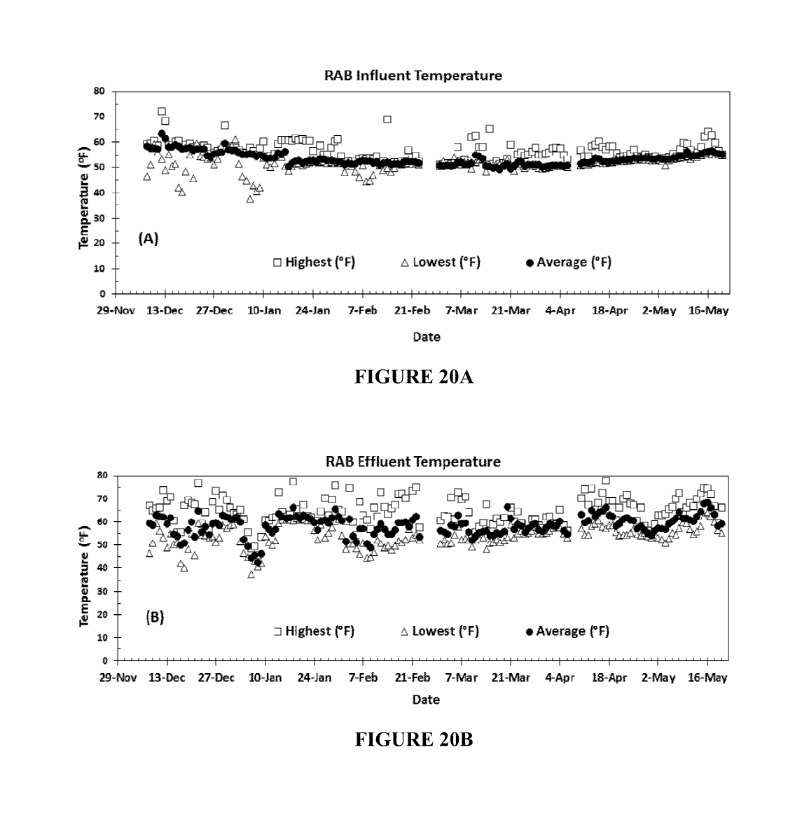

FIGS. 20A and 20B illustrate daily influent (FIG. 20A) and effluent (FIG. 20B) temperature for a pilot-scale RAB system. Throughout the approximately six month test period, the daily average temperature of the influent stayed between 50-60° F. with minimal fluctuation as shown in FIG. 20A. This demonstrates that placement of the RAB system before the wastewater enters the lagoon provides a great advantage, by using the heat in the wastewater. FIG. 20B shows the daily average temperature of the effluent during the time period.

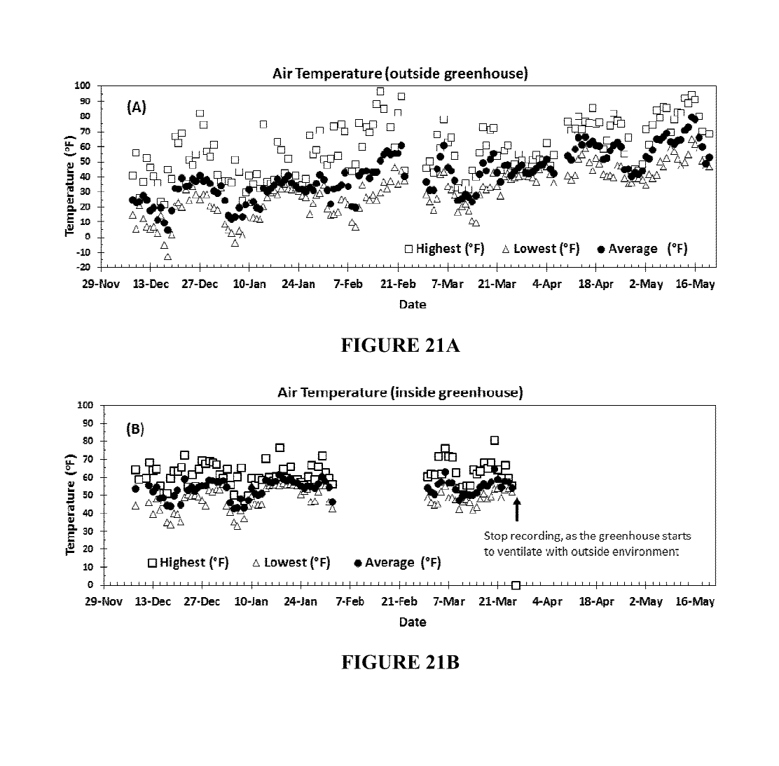

FIGS. 21A and 21B show the daily air temperature inside (FIG. 21A) and outside (FIG. 21B) the greenhouse. During the same period, the air temperature outside the greenhouse fluctuated widely from −10° F. to 90° F. as shown in FIG. 21A. Inside the greenhouse, the air temperature was relatively stable (from 40° F. to 80° F.) as shown in FIG. 21B. It should be noted that a heater was installed inside the greenhouse to maintain an air temperature of 50-60° F. on cold days. To cool the greenhouse on hot days, natural ventilation was used. This indicates the greenhouse environment is a perfect system for maintaining temperature, while minimizing heating and cooling costs. It should be noted that the RAB system only requires heating of the air in winter, not the wastewater, which results in lower heating costs.

The temperature profiles shown in 20A-21B demonstrate that the use of the raw wastewater (before entering the lagoon) and placement of the RAB system in a greenhouse environment is an ideal design for maintaining the temperature with minimal heating cost, even in the winter season. As a result, seasonality will not impact the treatment efficiency of the RAB system and the data supplied here is representative of what to expect year-round.

### Example 4

### Ammonia Removal

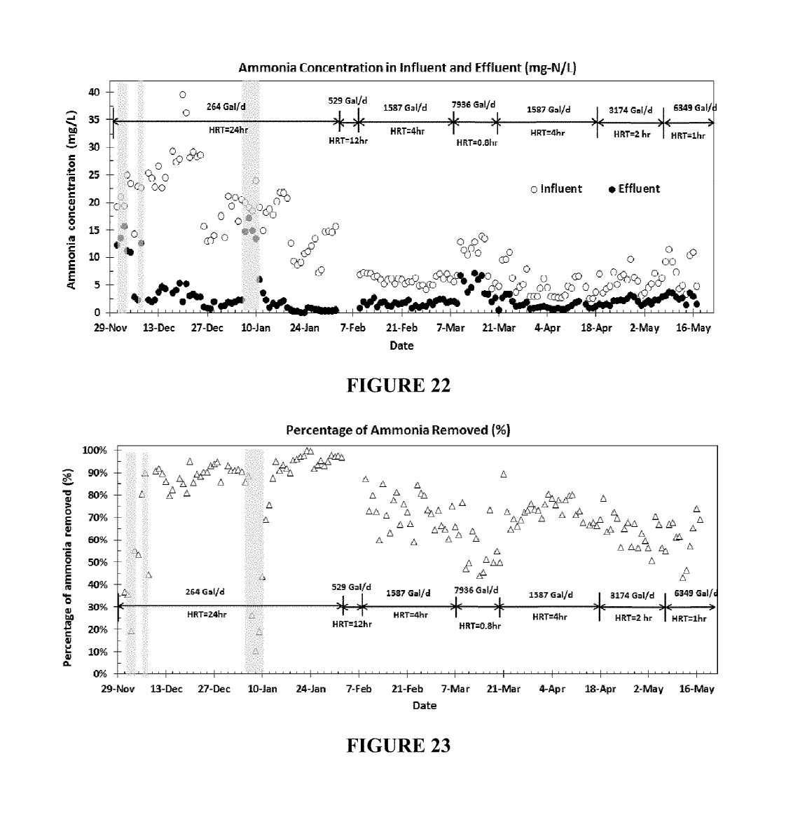

FIG. 22 illustrates the ammonia concentration in the influent (empty dots) and effluent (filled dots) of the pilot-scale RAB system. The shaded portions represent the periods when the RAB system was intentionally shutdown for testing how fast the treatment efficacy recovered. As shown in FIG. 22, the ammonia concentration in the influent drastically changed throughout the experimental period, probably due to rainfall and snowmelt during this period, which caused more inflow and infiltration that diluted the inflow. The effluent ammonia concentration was overall maintained in the low range, even when the influent ammonia concentration fluctuated significantly. It should be noted that in the earlier stage of operation, the RAB system experienced shutdowns, some of which were intentional to test how fast the RAB system could recover after a shutdown. The RAB system recovered treatment efficacy in a matter of 2-3 days (times of shutdown are designated in the shaded portions).

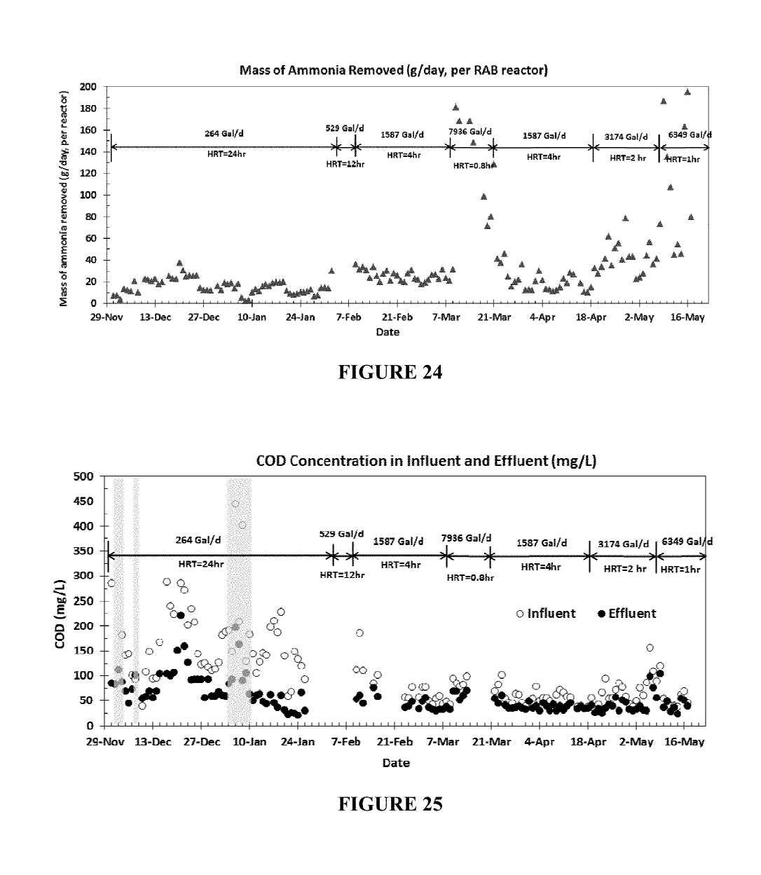

FIG. 23 shows that ammonia removal efficiency was 80-100% (daily flow of 264-529 gal/day, HRT=24-12 hr), 65-85% (daily flow of 1,587 gal/day, HRT=4 hr), 50-75% (daily flow of 3,174 gal/day, HRT=2 hr), and 40-70% (daily flow of 6,349-7,936 gal/day, HRT=1.0-0.8 hr). FIG. 24 shows the mass of ammonia removed by the pilot-scale RAB system. Although ammonia removal percentage decreased at the highest daily flow rate (6,349-7,936 gal/day, HRT=1.0-0.8 hr), the mass of ammonia removed increased as shown in FIG. 24.

### Example 5

### COD Removal Performance

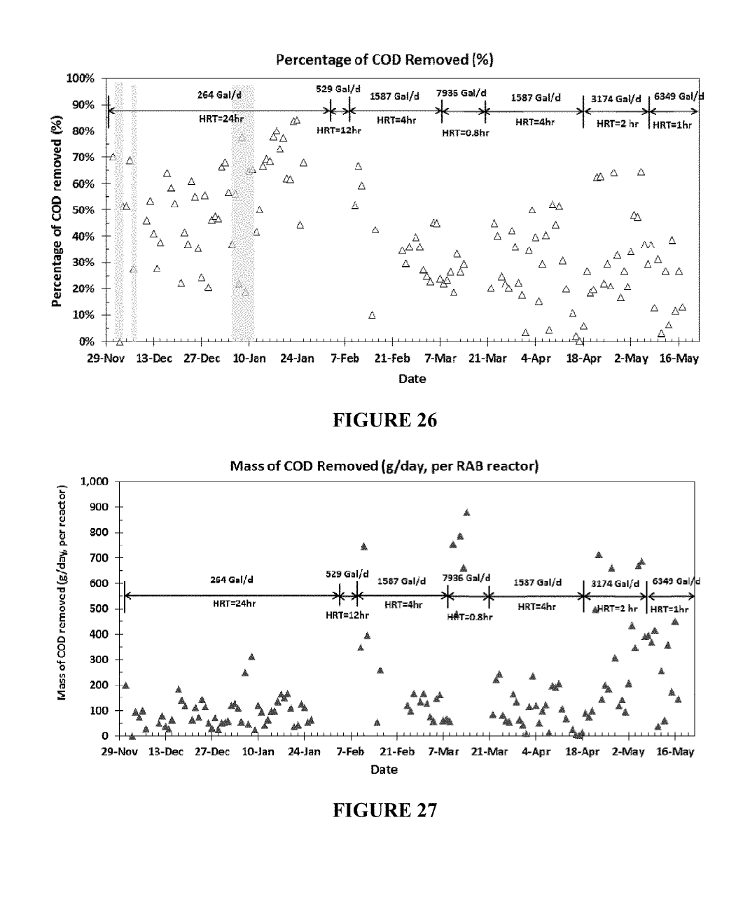

In addition to ammonia removal, the RAB system also removed a certain degree of COD in the influent as shown in FIGS. 25-27. FIG. 25 shows the COD concentration in the influent (empty dots) and effluent (filled dots) of the pilot-scale RAB system. FIG. 26 shows the percentage of COD removed during the testing period. The shaded portions in FIGS. 25 and 26 represent the period during which the RAB system was intentionally shutdown to test how quickly it recovers treatment efficacy. FIG. 27 illustrates the mass of COD removed by the pilot-scale RAB system.

The COD removal was due to the bacteria contained in the influent that were introduced into the RAB system, the rotation of the RAB belt in turn facilitated liquid aeration and thus, bacteria respiration.

### Example 6

### TSS of the Effluent

The TSS of the influent and effluent was determined during the period from days 161-168, during which the reactor flow rate was at a very high level (6,349 gal/day, HRT=1 hr). As shown in Table 1 below, the effluent TSS was overall lower than that of the influent, although two effluent samples had higher TSS than the influent. Overall, the TSS contained in the effluent of the RAB system is not a concern because it will be discharged to the existing lagoon for further solids settling.

TABLE 1
Total suspended solids (TSS) of the influent
and effluent of the RAB system.

TSS(mg/L)

| Day | Influent | Effluent |
|---|---|---|
| 161 | 45.0 | 19.0 |
| 162 | 23.7 | 14.8 |
| 163 | 67.5 | 19.7 |
| 164 | 36.8 | 16.8 |
| 165 | 9.3 | 13.0 |
| 166 | 165.5 | 32.9 |
| 167 | 95.3 | 9.7 |
| 168 | 24.8 | 39.6 |

Although preferred embodiments have been depicted and described in detail herein, it will be apparent to those skilled in the relevant art that various modifications, additions, substitutions, and the like can be made without departing from the spirit of the invention as defined in the claims which follow.

What is claimed:

1. A method for treating wastewater comprising:
treating an influent flow of raw wastewater from one or more sources in a harvestable algae biofilm treatment system; and
delivering the treated wastewater to one or more wastewater treatment lagoons or a mechanized biological treatment system for additional treatment.

2. The method of claim 1, wherein said treating is carried out at a minimum of between 40-70 degrees Fahrenheit.

3. The method of claim 1, wherein said treating is carried out at a minimum of between 50-60 degrees Fahrenheit.

4. The method of claim 1, wherein the harvestable algae biofilm treatment system is located upstream of the one or more wastewater treatment lagoons.

5. The method of claim 1, wherein the harvestable algae biofilm treatment system is within a greenhouse structure.

6. The method of claim 1 further comprising:
settling solids out of the influent flow of raw wastewater prior to said treating the influent flow of raw wastewater in the harvestable algae biofilm treatment system.

7. The method of claim 1 further comprising:
filtering the influent flow of raw wastewater prior to said treating the influent flow of raw wastewater in the harvestable algae biofilm treatment system.

8. The method of claim 7, wherein the influent flow of raw wastewater is filtered in a filtering system comprising a filter between about 100 nm and about 10 cm.

9. The method of claim 1, wherein the influent flow of raw wastewater has a residence time in the harvestable algae biofilm treatment system between about 0.8 hours and about 24 hours.

10. The method of claim 1, wherein the treated wastewater has a level of ammonia below that of said raw wastewater.

11. The method of claim 10, wherein the level of ammonia in the treated wastewater is 44-65%, 65-85%, 70-90%, or 80-100% below that of said raw wastewater.

12. The method of claim 1, wherein the treated wastewater has a chemical oxygen demand (COD) below that of said raw wastewater.

13. The method of claim 12, wherein the COD of the treated wastewater is between about 20% and about 60% below that of said raw wastewater.

14. The method of claim 1, wherein the treated wastewater has a level of total nitrogen and a level of total phosphorous below that of said raw wastewater.

15. The method of claim 1, wherein the treated wastewater has a level of at least one toxic element below that of said raw wastewater.

16. The method of claim 1 further comprising:
spiking the harvestable algae biofilm treatment system with microorganisms prior to said treating to enhance one or more of ammonia, total nitrogen, or total phosphorus removal during said treating.

17. The method of claim 1, wherein the harvestable algae biofilm treatment system is a revolving algal biofilm reactor system.

18. The method of claim 17, wherein the harvestable algae biofilm treatment system comprises:
a flexible sheet material, supporting the growth and attachment of algae, mounted on a frame, wherein the flexible sheet material has a substantially vertical orientation when mounted on the frame such that a height of the flexible sheet material is greater than a width of the flexible sheet material;
a drive system coupled with the frame to move the flexible sheet material;
a roller coupled with the frame to rotate the flexible sheet material, when the flexible sheet material is moved by the drive system, through a liquid zone and a gaseous zone, wherein in the liquid zone the flexible sheet material is rotated through a contacting liquid retained within a fluid reservoir and in the gaseous zone the flexible sheet material is rotated through a sunlight capture area, wherein a majority of the flexible sheet material is positioned within the gaseous zone and a minority of the flexible sheet material is positioned within the liquid zone; and
a harvesting mechanism positioned entirely within the sunlight capture area associated with the gaseous zone.

19. The method of claim 18, wherein the harvestable algae biofilm treatment system further comprises:
a raceway, wherein at least a portion of the raceway is positioned beneath the frame and the raceway at least partially defines the fluid reservoir.

20. The method of claim 19, wherein the harvestable algae biofilm treatment system further comprises:
an actuator configured to achieve liquid flow within the raceway, wherein the flexible sheet material is oriented such that an axis of rotation of the flexible sheet material is parallel to the liquid flow direction within the raceway.

21. The method of claim 18, wherein the drive system is coupled to a programmable controller that is configured to rotate the flexible sheet material at a predetermined schedule.

22. The method of claim 18, wherein the flexible sheet material has a roughened surface, is hydrophobic, and has a positive surface charge.

23. A water treatment system comprising:
a harvestable algae biofilm treatment system positioned to receive an influent flow of raw wastewater from one or more sources; and
a wastewater treatment lagoon coupled to the harvestable algae biofilm treatment system through one or more conduits to receive treated wastewater from the harvestable algae biofilm treatment system.
